(19) United States
(12) Patent Application Publication
(10) Pub. No.: US 2023/0066680 A1
(43) Pub. Date: Mar. 2, 2023

(54) ULTRA-LOW LOSS OPTICAL FIBER

(71) Applicant: Sterlite Technologies Limited, Gurgaon (IN)

(72) Inventors: Badri Gomatam, Gurgaon (IN); Nivedita Prasad, Gurgaon (IN); Chandan Saha, Gurgaon (IN)

(21) Appl. No.: 17/553,510

(22) Filed: Dec. 16, 2021

(30) Foreign Application Priority Data
Aug. 27, 2021 (EP) 20747685.4

(51) Int. Cl. G02B 6/02; C03B 37/012; C03C 13/04

(52) U.S. Cl. CPC G02B 6/02; C03B 37/01282; C03B 37/01211; C03C 13/046; C03C 2213/00

(57) ABSTRACT

An optical fibre including a core region defined along a central longitudinal axis of the optical fibre and a cladding region concentrically surrounds the core region of the optical fibre. In particular, the core region has a first radius r₁ and a first refractive index n₁. Moreover, the cladding has a second radius r₂ and a second refractive index n₂. Furthermore, the optical fibre has a step index profile.

### FIELD OF THE INVENTION

Embodiments of the present invention relate to the field of optical fibre. And more particularly, relates to an ultra-low loss optical fibre.

### BACKGROUND

Optical fibre communication has revolutionized the telecommunication industry in the past few years. The use of optical fibre cables has supported to bridge the gap between distant places around the world. One of the basic components of the optical fibre cable is an optical fibre. The optical fibre is responsible for carrying vast amount of information from one place to another. There are different methods for manufacturing glass bodies and optical fibres. These methods are primarily adopted to manufacture glass preform or glass preform. Few such methods employed for manufacturing optical fibres are powder-in-tube technique, rod-in-cylinder technique, vapor deposition techniques and the like. However, the currently available optical fibres have high attenuation losses.

One conventional type of optical fiber has a refractive index profile designed to confine the transmitted optical signal within the core region by adding germanium to the silica glass core, thereby increasing the refractive index of the core relative to the surrounding cladding. However, it has been found that germanium dopants cause optical loss of the transmitted signal (germanium increases Rayleigh scattering of light within the core material). To overcome this problem, some optical fibers have been fabricated with pure silica core (i.e., germanium-free core) thus minimizing optical loss due to scattering, etc. When a pure silica core is used, a special cladding material is needed that confines the transmitted optical mode to the core region by lowering the index of refraction of the cladding relative to the core (known in the art as “down doping” of the cladding). Fluorine is a dopant that has been used for this purpose, wherein the inclusion of fluorine dopants in the silica glass forming the cladding layer will lower the refractive index of the cladding layer relative to the core material within which the optical signal is confined.

While very beneficial for providing a low loss fiber structure with a germanium-free core, the arrangement of a pure silica core surrounded by a fluorine-doped cladding presents problems associated with its manufacture. Since fluorine-doped silica has a lower viscosity than pure silica, the act of heating the optical preform and subsequently drawing the preform into an optical fiber creates a situation where: wherein the more rigid core material is subjected to the main drawing tensions, resulting in a significant exponential decrease and high residual stresses in the core material area. This mechanical stress in turn creates glass defects which can act as scattering points and thereby increase optical attenuation.

Currently, the best solution to this residual stress problem is to reduce the draw tension by increasing the draw temperature and/or reducing the fiber draw rate, with a consequent increase in cost.

Thus, in light of the above stated discussion, there is a need to develop an optical fibre with extremely low attenuation loss that overcomes the above stated disadvantages and provides ease in manufacturing. Hence, the present invention focuses on an ultra-low loss optical fibre.

### SUMMARY OF THE INVENTION

Embodiments of the present invention relates to an ultra-low loss optical fibre. The ultra-low loss optical fibre comprising a core region which is defined along a central longitudinal axis of the optical fibre, a cladding region which is concentrically surrounding the core region of the optical fibre. In particular, the core region of the optical fibre has a first radius r₁ and a first refractive index n₁. Moreover, the cladding region of the optical fibre has a second radius r₂ and a second refractive index n₂. Further, the optical fibre has a step index profile. And, the step index profile corresponds to abrupt change in a value of refractive index.

In accordance with an embodiment of the present invention, the core region of the optical fibre is made of calcium aluminum silicate.

In accordance with an embodiment of the present invention, the cladding region of the optical fibre is made of fluorine doped silica. In particular, the cladding region of the optical fibre has the second radius r₂ of about 62.5 microns. Moreover, the cladding region of the optical fibre has the second refractive index n₂ of about 1.44. (1.42-1.44).

In accordance with an embodiment of the present invention, the core region has the first radius r₁ of about 38.35 microns. Particularly, the core region of the optical fibre has the first refractive index n₁ of about 1.625. (1.5-1.7). Moreover, the core region has the first radius r₁ of about 38.35 microns.

In accordance with an embodiment of the present invention, the optical fibre has low attenuation up to 0.1 decibel/kilometer.

In accordance with an embodiment of the present invention, the refractive index n₁ of the core region is greater than refractive index n₂ of the cladding region.

Another embodiment of the present invention relates to a method for manufacturing an ultra-low loss optical fibre from an optical fibre preform using anyone of a powder-in-tube technique, rod-in-cylinder technique.

In accordance with an embodiment of the present invention, the powder-in-cylinder technique includes steps of adding calcium aluminium silicate powder into hollow space inside a F-doped silica tube, and sintering the F-doped silica tube at a high temperature to form a glass preform.

In accordance with an embodiment of the present invention, the powder-in-cylinder technique facilitates the optical fibre preform to form a plurality of solid preform rods of small diameter.

In accordance with an embodiment of the present invention, sintering of the fluorine doped glass tube is performed at a temperature in range of about 1500 degree Celsius to 1600 degree Celsius.

In accordance with an embodiment of the present invention, the rod-in-cylinder technique includes steps of inserting a core rod assembly into a large cylindrical tube, and heating and collapsing the cylindrical tube onto the core rod assembly.

In accordance with an embodiment of the present invention, the fluorine doped silica forms a cladding region of the optical fibre and the calcium aluminum silicate forms a core region of the optical fibre.

In accordance with an embodiment of the present invention, the core region has the first radius r₁ of about 38.35 microns and the cladding region of the optical fibre has the second radius r₂ of about 62.5 microns.

In accordance with an embodiment of the present invention, the core region of the optical fibre has the first refractive index n₁ of about 1.625. (1.5-1.7)

In accordance with an embodiment of the present invention, the cladding region of the optical fibre has the second refractive index n₂ of about 1.44. (1.42-1.44)

In accordance with an embodiment of the present invention, the optical fibre has low attenuation up to 0.1 decibel/kilometer.

In accordance with an embodiment of the present invention, the refractive index n₁ of the core region is greater than refractive index n₂ of the cladding region.

The foregoing objectives of the present invention are attained by employing an ultra-low loss optical fibre and a method of manufacture thereof.

### BRIEF DESCRIPTION OF THE DRAWINGS

So that the manner in which the above recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a pictorial representation illustrating a cross-sectional view of an optical fibre in accordance with an embodiment of the present invention;

FIG. 1B is a block diagram illustrating the optical fibre in accordance with an embodiment of the present invention;

FIG. 2 is a pictorial snapshot illustrating a refractive index profile of the optical fibre 100 in accordance with various embodiments of the present disclosure.

FIG. 3 is a flow chart illustrating a method of manufacturing the optical fibre in accordance with one embodiment of the present invention.

FIG. 4 is a flow chart illustrating a method of manufacturing the optical fibre in accordance with another embodiment of the present invention.

### ELEMENT LIST

Ultra-low loss optical fibre—100
Core region—102
Cladding region—104
Central longitudinal axis—106
Refractive Index Profile—200

The method and the reduced diameter optical fibre preform are illustrated in the accompanying drawings, throughout which like reference letters indicate corresponding parts in the various figures. It should be noted that the accompanying figure is intended to present illustrations of exemplary embodiments of the present invention. This figure is not intended to limit the scope of the present invention. It should also be noted that the accompanying figure is not necessarily drawn to scale.

### DETAILED DESCRIPTION OF THE INVENTION

The present invention relates to an ultra-low loss optical fibre and a method of manufacture thereof.

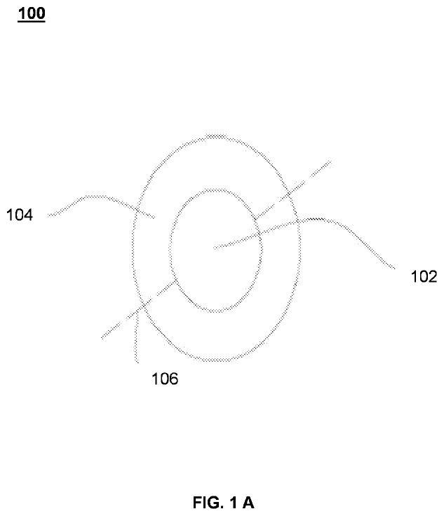

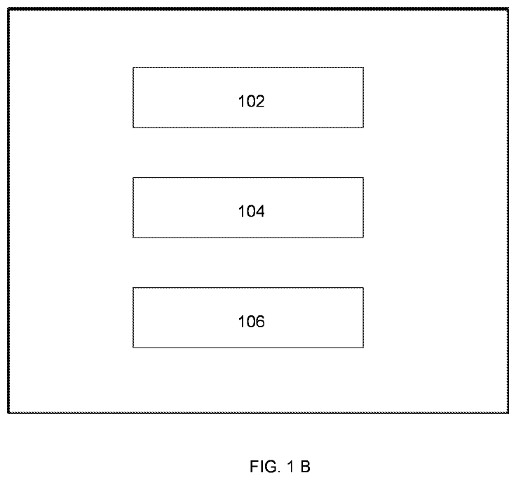

The principles of the present invention and their advantages are best understood by referring to FIG. 1A to FIG. 4. In the following detailed description numerous specific details are set forth in order to provide a thorough understanding of the embodiment of invention as illustrative or exemplary embodiments of the invention, specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The Following Brief Definition of Terms Shall Apply Throughout the Present Invention:

Optical fibre is used for transmitting information as light pulses from one end to another. In addition, optical fibre is a thin strand of glass or plastic capable of transmitting optical signals. Further, optical fibre allows transmission of information in the form of optical signals over long distances. Furthermore, optical fibre is used for a variety of purposes. The variety of purposes includes telecommunications, broadband communications, medical applications, military applications and the like.

Refractive index of a material is the ratio of speed of light in vacuum to speed of light in material.

Referring to FIGS. 1A and 1B, illustrating the ultra-low loss optical fibre 100, in accordance with various embodiments of the present disclosure. The ultra-low loss optical fibre 100 is an optical fibre with ultra-low losses optical fibre. In particular, the ultra-low loss optical fibre 100 includes a core region 102 and a cladding region 104. The core region 102 is an inner part of the ultra-low loss optical fibre 100. Moreover, the core region 102 is defined along a central longitudinal axis 106. The central longitudinal axis 106 is an imaginary axis. In addition, the core region 102 of the ultra-low loss optical fibre 100 has a first radius r₁ and a first refractive index n₁. Further, the core region 102 and the cladding region 104 are made during the manufacturing stage of an optical fibre preform.

In accordance with an embodiment of the present invention, the core region 102 has greater refractive index than that of the cladding region 104 of the ultra-low loss optical fibre 100. In particular, refractive index is maintained as per desired level based on concentration of chemicals used for the production of optical fibre preform.

In accordance with an embodiment of the present invention, the cladding region 104 of the ultra-low loss optical fibre 100 lies between the first radius r₁ and a second radius r₂. In particular, the cladding region 104 concentrically surrounds the core region 102 of the ultra-low loss optical fibre 100. Moreover, the cladding region 104 of the ultra-low loss optical fibre 100 has the second radius r₂ and a second refractive index n₂.

In accordance with an embodiment of the present invention, the ultra-low loss optical fibre 100 is a multimode fibre. The ultra-low loss optical fibre 100 is manufactured from the optical fibre preform.

The optical fibre preform may be manufactured by any conventional optical fibre preform manufacturing methods. Examples of such methods include powder-in-tube technique, rod-in-cylinder technique and the like. The optical fibre preform is made of glass. In general, glass is a non-crystalline amorphous solid, often transparent and has widespread applications. In general, the most common type of glass is silicate glass made of chemical compound silica. Moreover, the optical fibre preform is a large cylindrical body of glass having a core structure and a cladding structure. Further, the optical fibre preform is a material used for fabrication of optical fibres. And, the optical fibre preform is the optical fibre in a large form.

The core structure of the optical fibre preform is manufactured using a calcium aluminium silicate material. The calcium aluminium silicate material is a white free-flowing powder suited for making the core 102 of the ultra-low loss optical fibre 100. In particular, the calcium aluminium silicate material is a multicomponent glass material having superior optical properties. The cladding structure of the optical fibre preform is a fluorine doped silica (hereinafter “F-doped silica”) tube. The F-doped silica tube is a cylindrical shaped tube. Alternatively, the F-doped silica tube may have any other suitable shape.

In one embodiment of the present disclosure, the optical fibre preform may be manufactured using the powder-in-tube technology. The calcium aluminium silicate powder is added into hollow space inside the F-doped tube. Particularly, the powder-in-tube technology involves use of a glass cladding tube and a powdery substance. The powdery substance is used for forming the core 102 of the ultra-low loss optical fibre 100 and is inserted inside the glass cladding tube. Moreover, the glass tube is sintered at a high temperature to form a glass preform. The powder-in-tube technique is employed for manufacturing the optical fibre preform.

In an embodiment of the present disclosure, the optical fibre preform may be manufactured using the rod-in-tube method or RIC method. In general, the RIC method refers to a manufacturing process of a large-sized fibre preform by inserting a core rod assembly into a large cylindrical tube. The cylindrical tube is heated and collapsed onto the core rod assembly.

In an embodiment of the present disclosure, the calcium aluminum silicate material is utilized in a powdery form. In an embodiment of the present disclosure, the calcium aluminum silicate powder of a suitable size may be used. The size range may be selected such that the optical fibre preform can be manufactured. In an embodiment of the present disclosure, the optical fibre preform has a diameter of about 44 millimetres. In another embodiment of the present disclosure, the optical fibre preform may have any suitable diameter as per the requirement. In an embodiment of the present disclosure, the core structure of the optical fibre preform has a diameter of about 27 millimetres. In another embodiment of the present disclosure, the core structure of the optical fibre preform may have any suitable diameter as per the requirement.

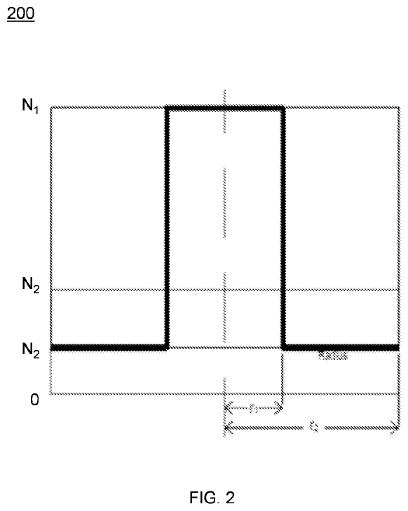

FIG. 2 is a pictorial snapshot illustrating a refractive index profile 200 of the ultra-low loss optical fibre 100 in accordance with various embodiments of the present disclosure. Particularly, the refractive index profile 200 defines the properties of the core region 102 of the ultra-low loss optical fibre 100. Moreover, the refractive index profile 200 illustrates a relationship between the refractive index of the core region 102 and the cladding region 104 with the first radius r₁ and the second radius r₂. In addition, the refractive index profile 200 illustrates change in refractive index of the optical fibre with an increase in radius. The performance of the ultra-low loss optical fibre 100 is monitored by controlling a plurality of parameters associated with the refractive index profile 200. Further, the refractive index profile 200 is determined based on a concentration of dopants and materials used during manufacturing. Furthermore, dispersion and bending losses are controlled by varying the design parameters of the refractive index profile 200.

In particular, the refractive index profile 200 is shown on ordinate axis or y-axis and the radius is shown on the abscissa or x-axis. The step index profile corresponds to a profile that has abrupt change in value of the refractive index. In addition, the first refractive index n₁ is of the core region 102 and the second refractive index n₂ is of the cladding region 104 of the optical fibre.

In an embodiment of the present disclosure, n₁ corresponds to the refractive index of the calcium aluminum silicate material and n₂ corresponds to the refractive index of the F-doped Silica.

In an embodiment of the present disclosure, the first refractive index n₁ of the core region 102 of the ultra-low loss optical fibre 100 is about 1.625. Alternatively, the value of the first refractive index of the core region 102 of the ultra-low loss optical fibre 100 may vary.

In an embodiment of the present disclosure, the second refractive index n₂ of the cladding region 104 of the ultra-low loss optical fibre 100 is about 1.44. Alternatively, the value of the second refractive index n₂ of the cladding region 104 may vary.

In an embodiment of the present disclosure, the first radius r₁ of the core region 102 the ultra-low loss optical fibre 100 is about 38.35 microns. Alternatively, the value of the first radius r₁ of the core region 102 of the ultra-low loss optical fibre 100 may vary.

In an embodiment of the present disclosure, the second radius r₂ of the cladding region 104 of the ultra-low loss optical fibre 100 is about 62.5 microns. Alternatively, the value of the second radius r₂ of the cladding region 104 of the ultra-low loss optical fibre 100 may vary.

In accordance with an embodiment of the present invention, the ultra-low loss optical fibre 100 has low attenuation up to 0.1 decibel/kilometer. Alternatively, the low attenuation may vary.

In an embodiment of the present disclosure, the core region 102 of the ultra-low loss optical fibre 100 is made of calcium aluminum silicate. Alternatively, the core region 102 of the ultra-low loss optical fibre 100 may be made of any suitable material. In an embodiment of the present disclosure, the cladding region 104 of the ultra-low loss optical fibre 100 is made of fluorine doped silica. Alternatively, the cladding region 104 of the ultra-low loss optical fibre 100 may be made of any suitable material.

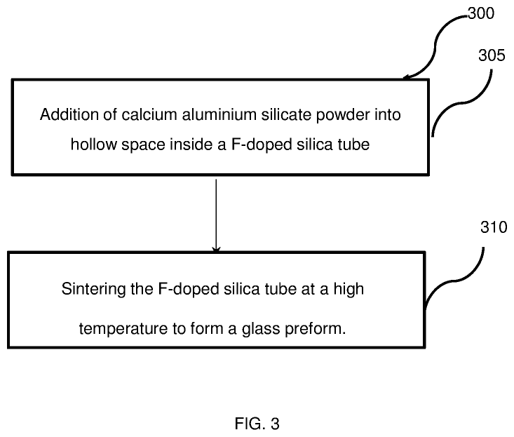

FIG. 3 is a flow chart illustrating a method of manufacturing the optical fibre in accordance with one embodiment of the present invention. Method 300 starts at step 305, and proceeds to step 310.

At step 305, the calcium aluminium silicate powder is added into a hollow space inside a F-doped silica tube.

At step 310, the F-doped silica tube is sintered at a high temperature to form a glass preform.

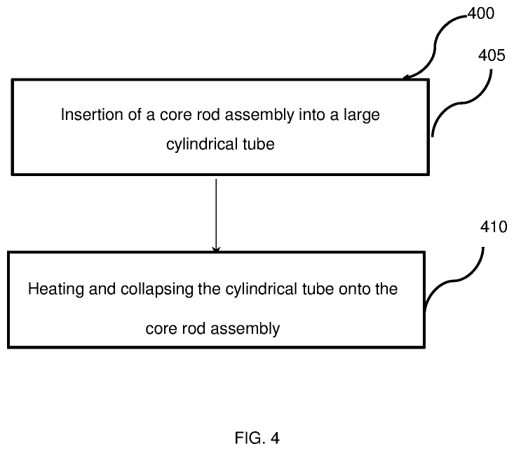

FIG. 4 is a flow chart illustrating a method of manufacturing the optical fibre in accordance with another embodiment of the present invention. Method 400 starts at step 405, and proceeds to step 410.

At step 405, the core rod assembly is inserted into a large cylindrical tube.

At step 410, the cylindrical tube is heated and collapsed onto the core rod assembly.

The present invention for ultra-low loss optical fibre provides an optical fibre with low attenuation and transmitting ability in the infrared region.

The foregoing descriptions of pre-defined embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed for:

1. An ultra-low loss optical fibre comprising:
a core region, defined along a central longitudinal axis of the optical fibre, wherein the core region of the optical fibre has a first radius r₁ and a first refractive index n₁; and
a cladding region, concentrically surrounding the core region of the optical fibre, wherein the cladding region of the optical fibre has a second radius r₂ and a second refractive index n₂,
wherein the optical fibre has a step index profile, and the step index profile corresponds to abrupt change in a value of refractive index.

2. The optical fibre as claimed in claim 1, wherein the core region of the optical fibre is made of calcium aluminum silicate.

3. The optical fibre as claimed in claim 1, wherein the cladding region of the optical fibre is made of fluorine doped silica.

4. The optical fibre as claimed in claim 1, wherein the core region has the first radius r₁ of about 38.35 microns.

5. The optical fibre as claimed in claim 1, wherein the cladding region of the optical fibre has the second radius r₂ of about 62.5 microns.

6. The optical fibre as claimed in claim 1, wherein the core region of the optical fibre has the first refractive index n₁ of about 1.625. (1.5-1.7)

7. The optical fibre as claimed in claim 1, wherein the cladding region of the optical fibre has the second refractive index n₂ of about 1.44. (1.42-1.44)

8. The optical fibre as claimed in claim 1, wherein the optical fibre has low attenuation up to 0.1 decibel/kilometer.

9. The optical fibre as claimed in claim 1, wherein the refractive index n₁ of the core region is greater than refractive index n₂ of the ladding region.

10. A method for manufacturing an ultra-low loss optical fibre from an optical fibre preform using anyone of a powder-in-tube technique, rod-in-cylinder technique.

11. The method as claimed in claim 10, wherein the powder-in-cylinder technique includes steps of:
adding calcium aluminium silicate powder into hollow space inside a F-doped silica tube; and
sintering the F-doped silica tube at a high temperature to form a glass preform.

12. The method as claimed in claim 11, wherein the powder-in-cylinder technique facilitates the optical fibre preform to form a plurality of solid preform rods of small diameter.

13. The method as claimed in claim 11, wherein sintering of the fluorine doped glass tube is performed at a temperature in range of about 1500 degree Celsius to 1600 degree Celsius.

14. The method as claimed in claim 10, wherein the rod-in-cylinder technique includes steps of
inserting a core rod assembly into a large cylindrical tube; and
heating and collapsing the cylindrical tube onto the core rod assembly.

15. The method as claimed in claim 10, wherein the fluorine doped silica forms a cladding region of the optical fibre and the calcium aluminum silicate forms a core region of the optical fibre.

16. The method as claimed in claim 15, wherein the core region (102) has the first radius r₁ of about 38.35 microns and the cladding region (104) of the optical fibre has the second radius r₂ of about 62.5 microns.

17. The method as claimed in claim 15, wherein the core region of the optical fibre has the first refractive index n₁ of about 1.625. (1.5-1.7)

18. The method as claimed in claim 15, wherein the cladding region (104) of the optical fibre has the second refractive index n₂ of about 1.44. (1.42-1.44)

19. The method as claimed in claim 15, wherein the optical fibre has low attenuation up to 0.1 decibel/kilometer.

20. The method as claimed in claim 15, wherein the refractive index n₁ of the core region is greater than refractive index n₂ of the ladding region.
